(19) United States
(12) Patent Application Publication
(10) Pub. No.: US 2023/0388570 A1
(43) Pub. Date: Nov. 30, 2023

(54) METHOD AND APPARATUS FOR ADAPTIVE BIT STREAMING USING CONSUMPTION CONTEXT

(71) Applicants: AT&T Intellectual Property I, L.P., Atlanta, GA (US); University of Connecticut, Farmington, CT (US)

(72) Inventors: Subhabrata Sen, Westfield, NJ (US); Bing Wang, Storrs Mansfield, CT (US); Chinmaey Shende, Farmington, CT (US); Cheon Jin Park, Farmington, CT (US)

(73) Assignees: AT&T Intellectual Property I, L.P., Atlanta, GA (US); University of Connecticut, Farmington, CT (US)

(21) Appl. No.: 18/064,163

(22) Filed: Dec. 9, 2022

Related U.S. Application Data
(60) Provisional application No. 63/346,518, filed on May 27, 2022.

(51) Int. Cl. H04N 21/2662; H04N 21/845; H04N 21/234

(52) U.S. Cl. CPC H04N 21/2662; H04N 21/845; H04N 21/23418

(57) ABSTRACT

Aspects of the subject disclosure may include a method including steps of, for each segment of a content item during presentation of a content item, obtaining current consumption context information, determining a current consumption context for the segment according to the consumption context information, selecting a filtered set of audio track and video track variants for the segment according to the current consumption context and track variant information, selecting an audio track and a video track for the segment from the filtered set of audio track and video track variants according to a dynamic network condition, receiving a data stream for the segment from a server over a network including the audio track and the video track for the segment, and presenting the segment of the content item according to the audio track and the video track via a video output and an audio output. Other embodiments are disclosed.

### CROSS-REFERENCE TO RELATED APPLICATIONS

This application claims the benefit of priority to U.S. Provisional Application No. 63/346,518, filed May 27, 2022. The contents of the foregoing are hereby incorporated by reference into this application as if set forth herein in full.

### FIELD OF THE DISCLOSURE

The subject disclosure relates to a method and apparatus for adaptive bit streaming using consumption context

### BACKGROUND

Modern telecommunications systems provide consumers with telephony capabilities while accessing a large variety of content. Consumers are no longer bound to specific locations when communicating with others or when enjoying multimedia content or accessing the varied resources available via the Internet. Network capabilities have expanded and have created additional interconnections and new opportunities for using mobile communication devices in a variety of situations. Intelligent devices offer new means for experiencing network interactions in ways that anticipate consumer desires and provide solutions to problems.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts the selection of audio and video tracks during a video session.

FIG. 2C depicts a block diagram of an audio system.

FIG. 2D depicts audio quality measurements for downmixing six-channel audio to a two-channel (stereo) device.

FIG. 2E depicts audio quality measurements for downmixing six-channel audio to a two-channel (stereo) device.

FIG. 2F depicts differences between two adaptive bit rate protocols, DASH and HLS.

FIG. 2G depicts an illustrative embodiment of an example, non-limiting embodiment of a system in accordance with various aspects described herein.

FIG. 2H depicts an illustrative embodiment of a method in accordance with various aspects described herein.

FIG. 2I depicts an illustrative embodiment of a method in accordance with various aspects described herein.

FIG. 2J-2K depict audio/video quality and data usage measurements for playback of content on a phone device during periods of low and high network bandwidth.

FIG. 2L depicts content quality and bandwidth usage for playback on a phone device over a home WiFi network.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for adjusting a streaming bit rate of a content item during a video session by selecting audio/video tracks based on consumption context. The consumption context is determined from consumption context information obtained from the device. Selections of audio/video tracks are made based on the consumption context and consumption policy to optimize quality of experience and bit rate. Other embodiments are described in the subject disclosure.

One or more aspects of the subject disclosure include a method performing operations by a processing system including a processor. The method can include receiving track variant information from a server over a network, where the track variant information can describe a plurality of audio track and video track variants for a plurality of segments of a content item. For each segment of the plurality of segments of the content item during presentation of the content item, the method can also include obtaining current consumption context information, and, in turn, determining a current consumption context for the segment according to the current consumption context information, where the current consumption context can include a video output characteristic, an audio output characteristic, and a network characteristic. For each segment of the plurality of segments of the content item, the method can further include selecting a filtered set of audio track and video track variants for the segment from a plurality of audio track and video track variants for the content item according to the current consumption context, the track variant information, and a consumption policy. For each segment of the plurality of segments of the content item, the method can include determining a dynamic condition for the segment, and, in turn, selecting an audio track and a video track for the segment from the filtered set of audio track and video track variants for the segment according to the dynamic network condition. For each segment of the plurality of segments of the content item, the method can include receiving a data stream for the segment from the server over the network, where the data stream can include the audio track and the video track for the segment selected from the filtered set of audio track and video track variants that are selected and, in turn, presenting the segment of the content item according to the audio track and the video track via a video output and an audio output.

One or more aspects of the subject disclosure include a device, comprising a processing system including a processor and a memory that stores executable instructions that, when executed by the processing system, facilitate performance of operations including receiving track variant information from a server over a network, wherein the track variant information describes a plurality of audio track and video track variants for a plurality of segments of a content item. For each segment of the plurality of segments of the content item during presentation of the content, the operations can also include obtaining current consumption context information and, in turn, determining a current consumption context for the segment according to the consumption context information. For each segment of the plurality of segments of the content item the operations can further include selecting a filtered set of audio track and video track variants for the segment from the plurality of audio track and video track variants for the content item according to the current consumption context, the track variant information, and a consumption policy. For each segment of the plurality of segments of the content item the operations can include determining a dynamic network condition for the segment and, in turn, selecting an audio track and a video track for the segment from the filtered set of audio track and video track variants for the segment according to the dynamic network condition. For each segment of the plurality of segments of the content item the operations can include receiving a data stream for the segment from the server over the network including the audio track and the video track for the segment selected from the filtered set of audio track and video track variants according to the dynamic network condition and, in turn, presenting the segment of the content item according to the audio track and the video track for a plurality of segments of the content item via a video output and an audio output.

One or more aspects of the subject disclosure include a non-transitory machine-readable medium, comprising executable instructions that, when executed by a device comprising a processing system including a processor, facilitate performance of operations including, for each segment of a plurality of segments of a content item during presentation of the content item, obtaining current consumption context information and, in turn, determining a current consumption context for the segment according to the consumption context information. For each segment of a plurality of segments of a content item, the operations can also include selecting a filtered set of audio track and video track variants for the segment from a plurality of audio track and video track variants for the plurality of segments of the content item according to the current consumption context and track variant information. For each segment of a plurality of segments of a content item, the operations can further include selecting an audio track and a video track for the segment from the filtered set of audio track and video track variants for the segment according to a dynamic network condition. For each segment of a plurality of segments of a content item, the operations can further include receiving a data stream for the segment from a server over a network including the audio track and the video track from the filtered set of audio track and video track variants according to the dynamic network condition and, in turn, presenting the segment of the content item according to the audio track and the video track for a plurality of segments of the content item via a video output and an audio output.

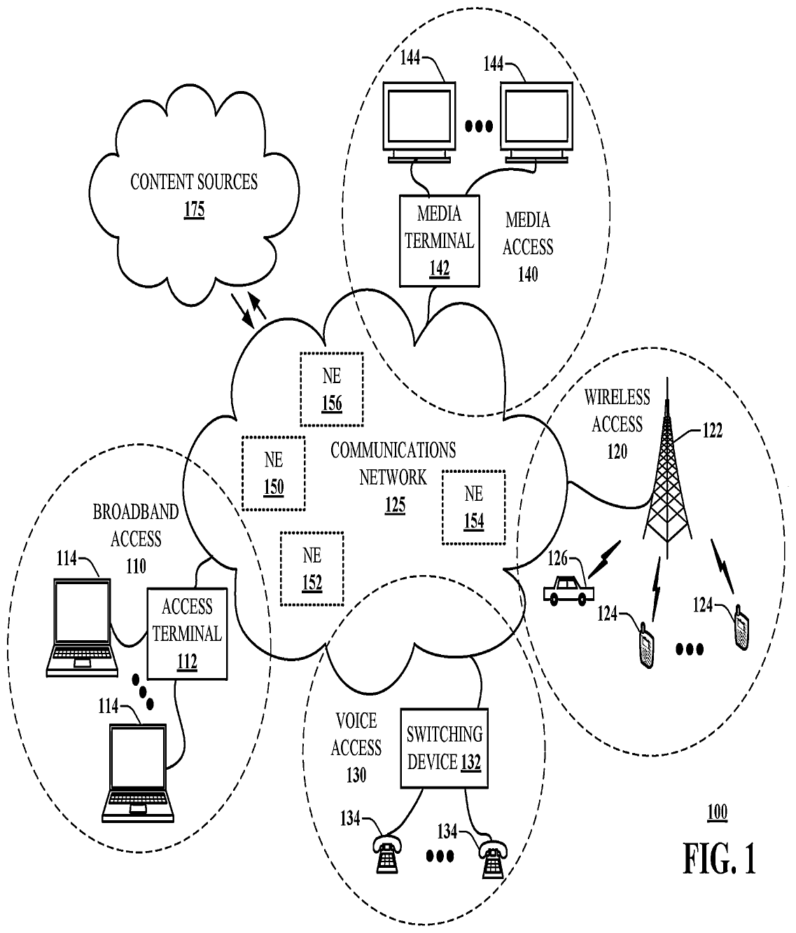

Referring now to FIG. 1, a block diagram is shown illustrating an example, non-limiting embodiment of a system 100 in accordance with various aspects described herein. For example, system 100 can facilitate in whole or in part adjusting a streaming bit rate of a content item during a video session by selecting audio/video tracks based on consumption context. The consumption context is determined from consumption context information obtained from the device. Selections of audio/video tracks are made based on the consumption context and consumption policy to optimize quality of experience and bit rate. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

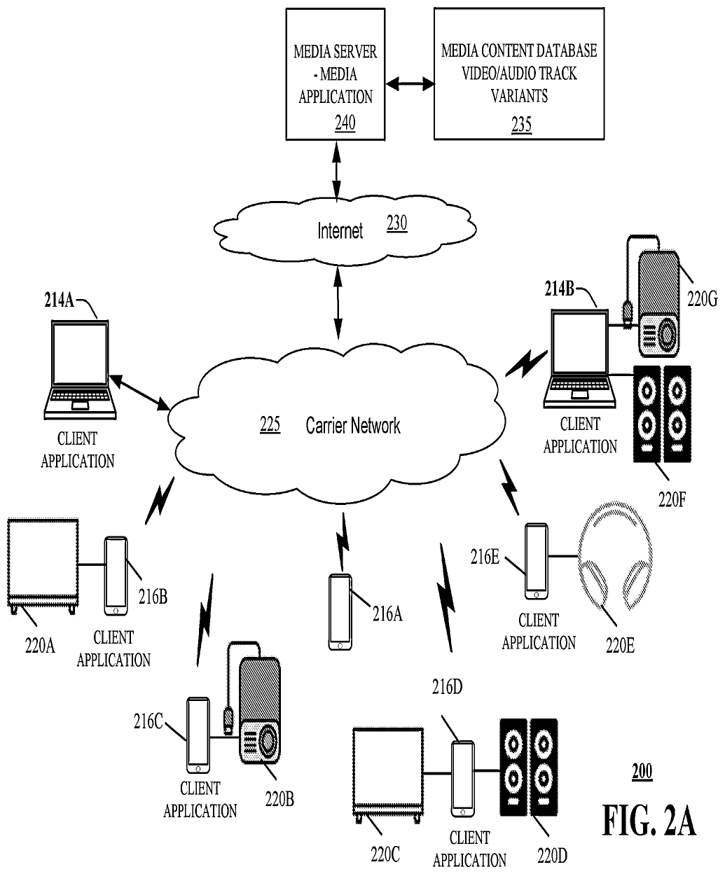

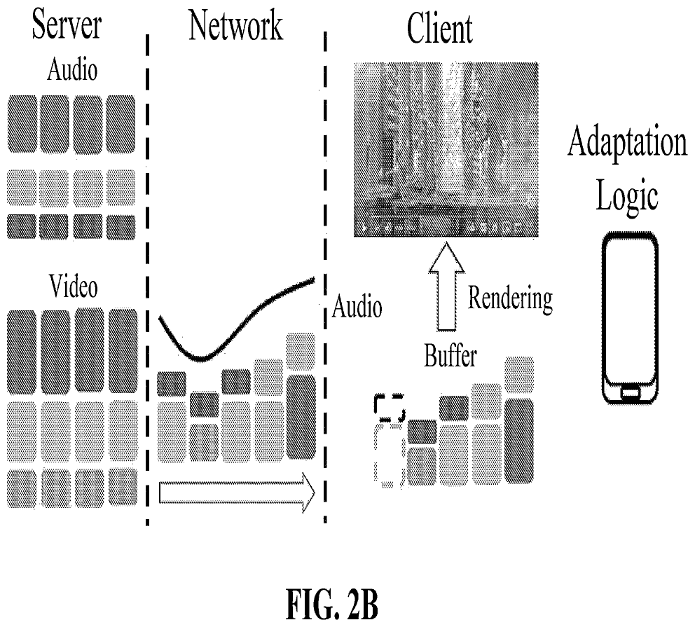

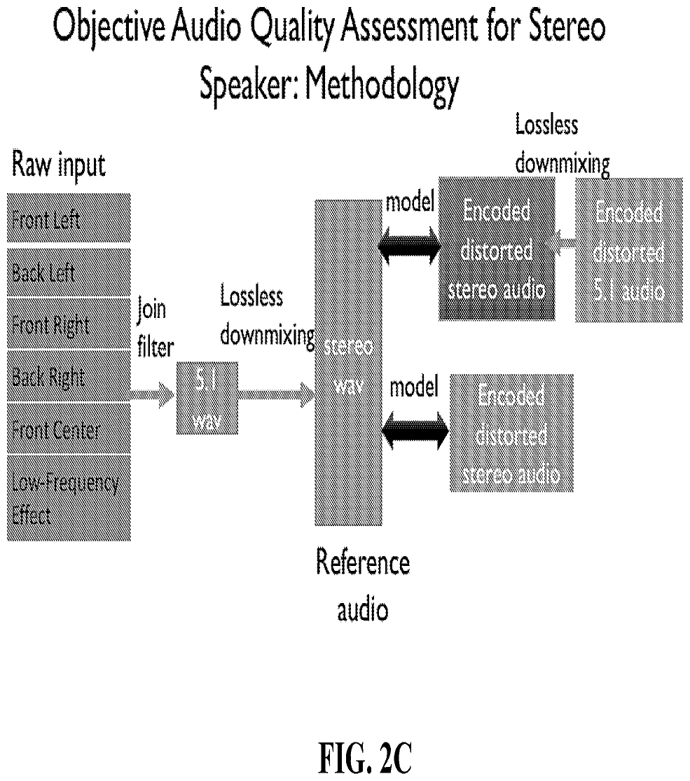

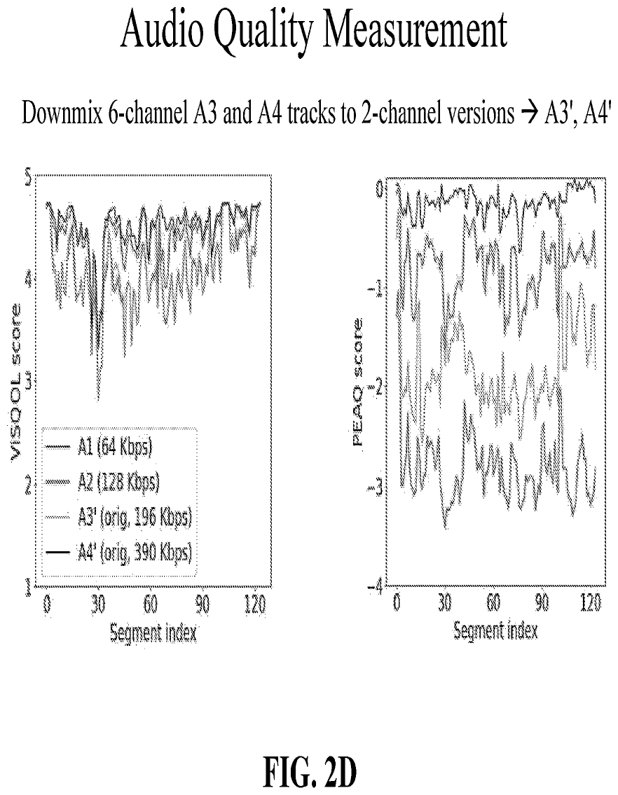

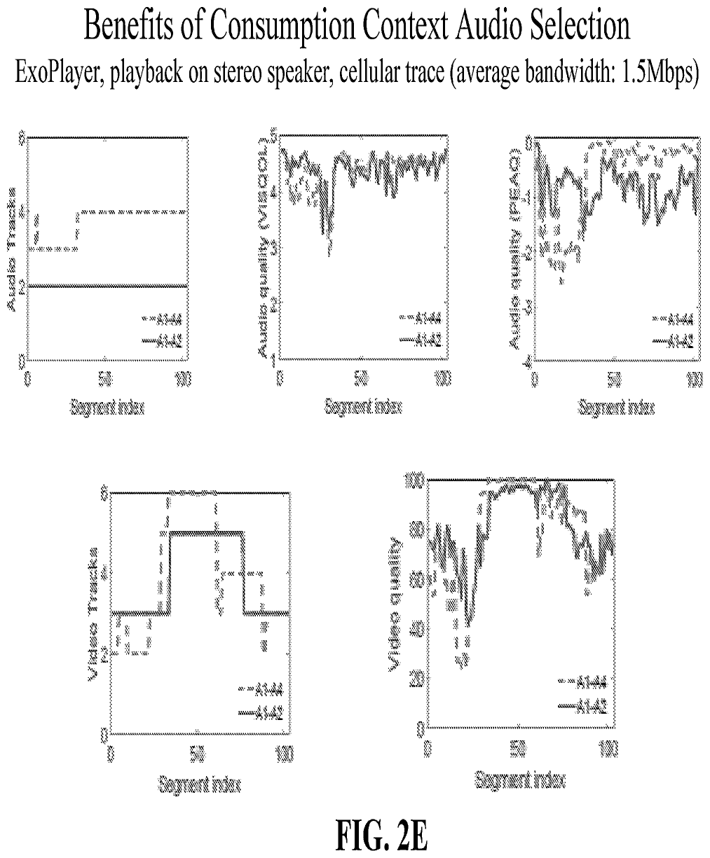

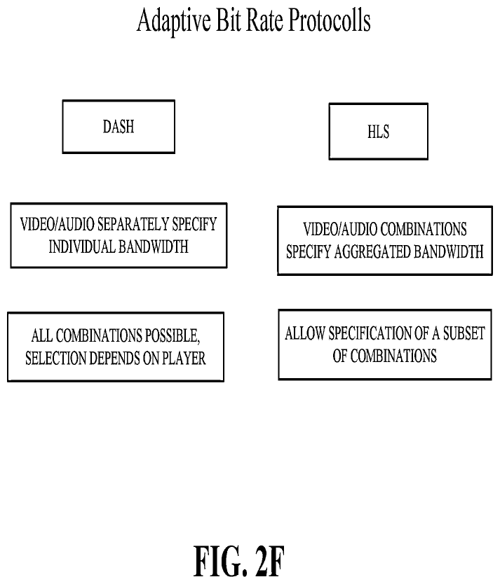

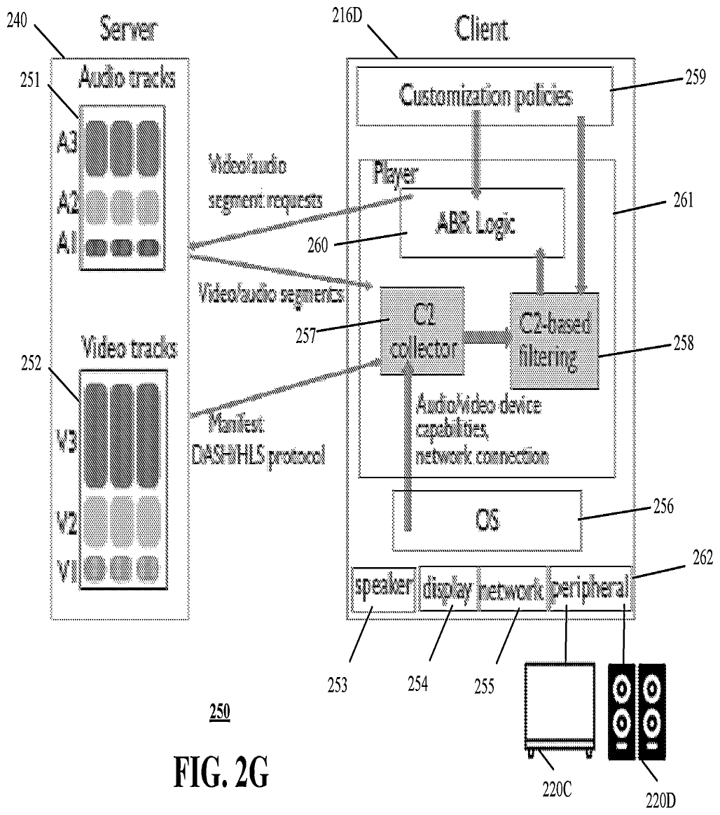

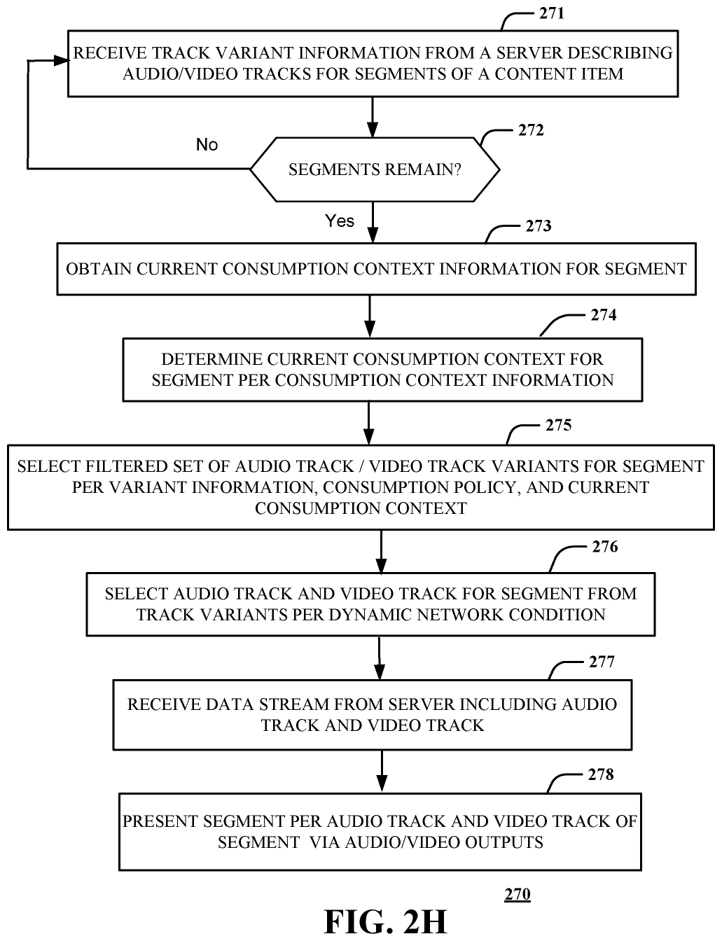

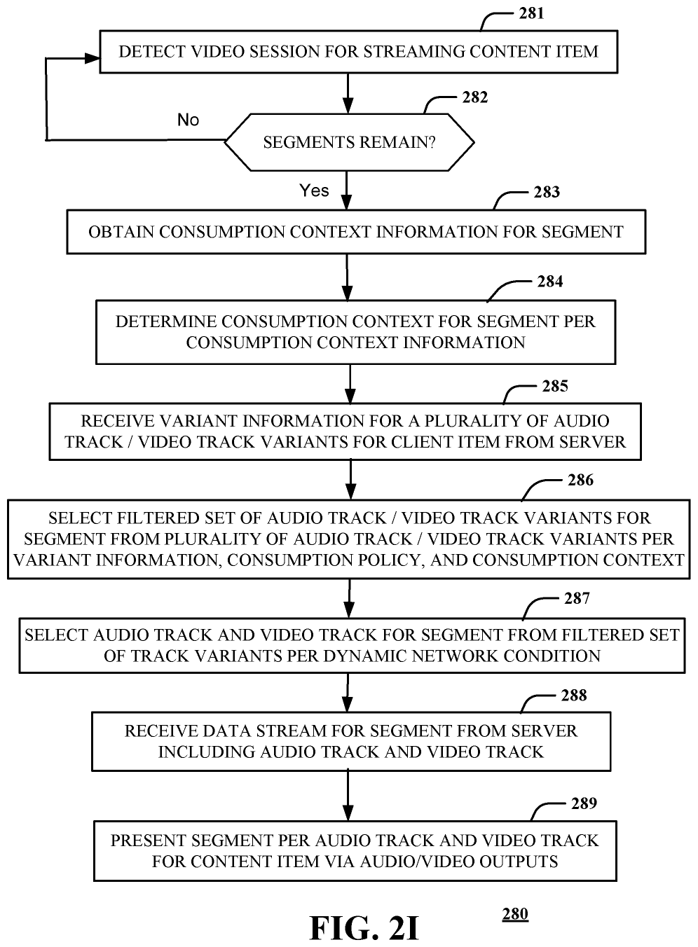

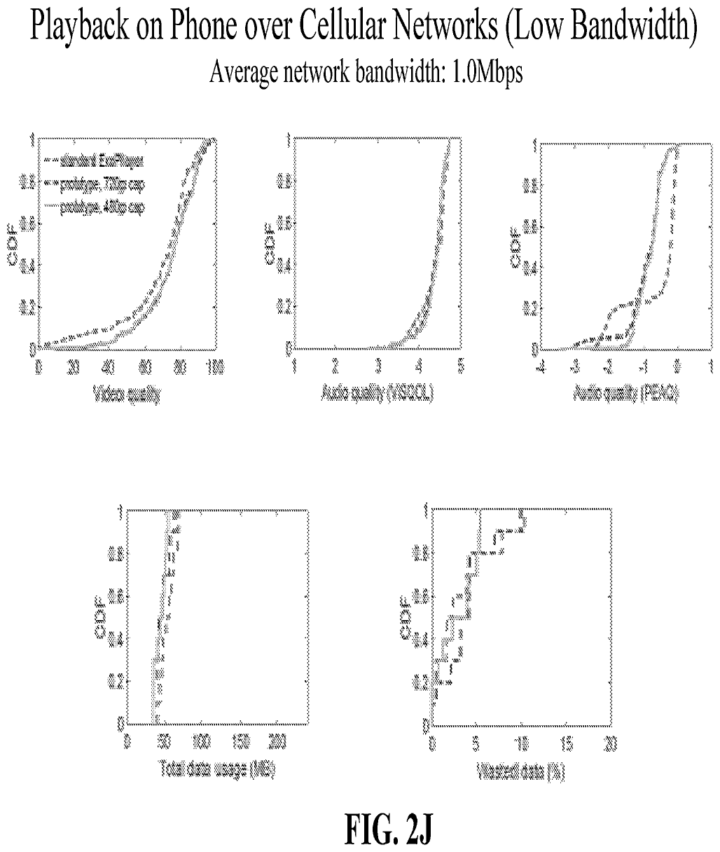

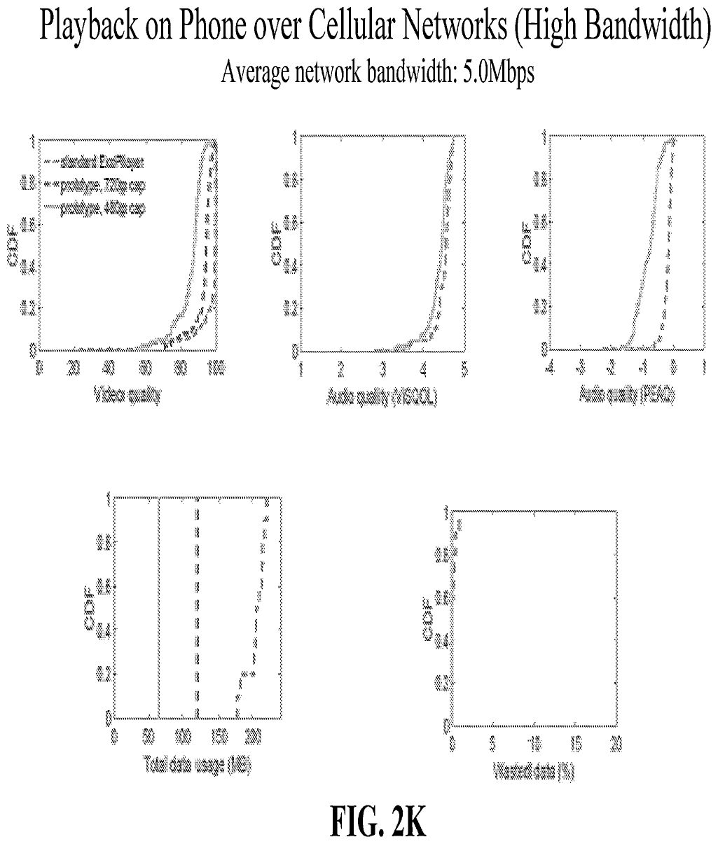

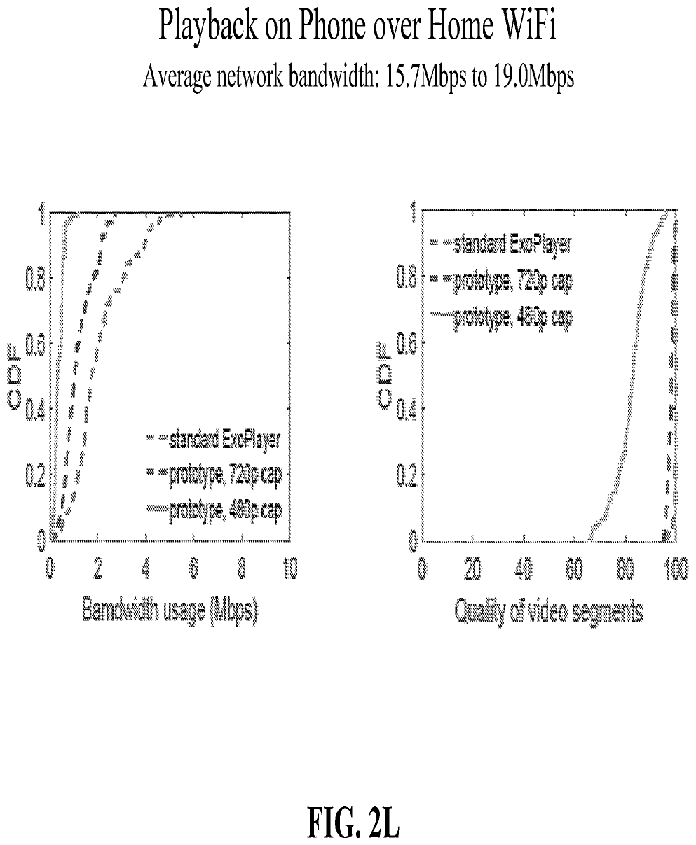

FIG. 2A is a block diagram illustrating an example, non-limiting embodiment of a system functioning within the communication network of FIG. 1 in accordance with various aspects described herein. In one or more embodiments, a communication system 200 can include an Internet network 230 for generalized global communication and a carrier network 225 for delivering communication services to subscribers. The subscribers can connect to the carrier network 225 via various types of communication devices, including computing devices 214A-B and mobile device 216A-F, among others. Any of the communication device 216A can use the carrier network 225 and Internet network 230 to access information and services. For example, a media server 240 can provide access to media content, such as movies, television programs, video content, audio content to a communication device via the Internet network 230 and the carrier network 225. The media server 240 can include a media application that can provide a listing available content to a client application running at the communication device 216A.

A user of the communication device 216A can navigate a user interface in the client application to select a content item to watch or listen to. The media application at the media server 240 can contact a media content database 235. The media content database 235 can include copies of the content items. Each content item, such as an individual movie, can include a large number of segments. For example, a movie can be broken into a thousand segments. Each segment includes video track and audio track data for a short sequence of the movie, such as a ten second snippet of the movie. Further, each segment can have multiple variations for the video track and audio track data. For example, a segment can include several video track variants to facilitate different display densities, including 4K, 1020p (HD), 720p, 480p, 360p, 240p, and 144p. The segment can also include several audio track variations to facilitate different audio reproduction systems, including mono, stereo, and surround sound (six channel audio).

In one or more embodiments, the communication device 216A can have various means for presentation/reproduction of video and audio. Typically, communication devices 216A will include video and audio capabilities, such as a built-in display screen and a speaker. However, various peripheral devices can be coupled to the communication device 216A, by wired or wireless connection, to provide enhanced video and/or audio capabilities. For example, a video monitor 220A can be coupled to a communication device 216B through a USB or wireless connection. Similarly, a video projection system 220B can be coupled to a communication device 216C. External headphones 220E or earbuds can be coupled to a communication device 216E in a wired or wireless configuration. Similarly, an external speaker system 220D can coupled to a communication device 220C. Multiple peripheral devices can be used, such as coupling both a video projection system 220G and an external set of speakers 220F to a computer device 214B or a video monitor 220C and an external set of speakers 220D to a mobile device 216.

In one or more embodiments, mobile devices 216A, such as smart phones, have become a ubiquitous computing platform for consumption of content in a wide range of contexts. Users can listen to audio/music on mobile devices 216A, using either the built-in speaker, or headphones 220E that can have produce spatial audio. Users can watch video using the small built-in display screen, unfold a flip screen to a larger display, use a built-in projector, or attach mini external projector 220B that projects the content to a larger space. In addition, communication devices 216D can be conveniently connected to play content on external peripherals, such as large-screen and high resolution video TV/monitor devices 220C and/or 5.1 or 7.2 channel audio surround sound systems. For example, a mobile device 216D can be used at a “Tailgate party” in a parking lot of a stadium or arena, before and after a games and concerts, to provide “home theatre quality” video and audio by using a peripheral video monitor 220C and/or audio sound system 220D. The mobile device 216D provides the connectivity for accessing streaming content, live or previously recorded, from a media server 240, processing video and audio from the streamed data, and providing video and/or audio to the external peripherals 220C and 220D. The ubiquitous network connectivity to mobile devices 216D, through cellular or WiFi, further allows users to access the Internet anytime anywhere.

In one or more embodiments, the device environment in which a user consumes this content (i.e., watches and/or listens) can be referred to as a consumption context. The consumption context can include the network connection, such as whether the network connection is cellular or WiFi, and/or the specific setup of the audio/video device, such as playing directly using the built-in speaker or native display of the mobile device 216A or using external peripherals, such as a video monitor 220C or sound system 200D. The consumption context can also include the capability of specific audio/video device used for playback (e.g., stereo speaker, or 5.1 channel surround sound system, size and resolution of the display), and/or a streaming protocol used between the player and server (e.g., DASH or HLS). The consumption context can also include multimedia decoding capabilities (e.g., codecs, and highest frame rate, resolution supported), and/or other information (e.g., screen orientation). As examples, streaming a video over a cellular connection to a mobile device 216A and viewing the content on the mobile device 216A involves one type of consumption context, while viewing the video on an external TV monitor 220A would be another type of consumption context.

It is found that, for delivery of good quality of experience (QoE), different types of consumption context can require different resource requirements and user needs. Therefore, knowing the consumption context can be important for many applications to appropriately optimize user experience and resource usage. In one or more embodiments, the consumption context can be incorporated in adaptive bitrate (ABR) streaming, which is generally the de facto technology used for video streaming over the Internet. It is found that consumption context can be holistically integrated into the entire end-to-end path of ABR streaming, including the server, CDN, client and the network, due to the large amount of resources and bandwidth consumed by video streaming. Optimizing QoE while reducing resource consumption is clearly relevant for resource-constrained cellular networks. However, even for relatively resource-richer broadband settings, optimizing the tradeoff between QoE and resource usage can be relevant since many people have multiple devices running multiple applications concurrently. It is important to ensure that the resource intensive video streaming applications do not use more bandwidth than necessary for the consumption context.

However, the state of the art in using consumption context to make ABR streaming decisions is very limited. The various limitations in the current video player designs are problematic and can lead to substantial resource usage as well as degradation in QoE for users. For example, current video player designs can result in undesirable behaviors including unnecessarily high network data usage due to the player selecting very high bitrate video tracks containing ultra-high resolution content to stream for consumption on small phone screen devices with limited resolution. This approach does not offer any commensurate QoE benefits to the user and, in fact, can potentially degrade user QoE due to the increasing potential of stalls as a result of selecting and streaming very high bitrate tracks over networks under variable bandwidth conditions. Very little understanding proper design of consumption context-cognizant adaptation in ABR streaming is found in the prior art. It is found that ABR adaptation based on consumption context can be a challenging problem involving a number of different dimensions and tradeoffs and requiring a holistic solution.

In one or more embodiments, the system 200 can identify various specific consumption contexts during a video session. These consumption contexts can be critical factors that can be considered during ABR streaming, when making decisions about what quality video and audio to stream in the video session and optimizing QoE and network resource usage. A consumption context-cognizant approach can facilitate selection of video and audio track variants from an ABR track ladder that can better match specific consumption needs and improve QoE, while avoiding wasting scarce network resources due to selecting and streaming unnecessarily high bitrate track variants. The consumption context method can work with many types of IP networks, wired or wireless, including cellular networks and home access networks, which in many cases, are bandwidth constrained. Clearly, this can be particularly valuable when a mobile device 216A is connected to a cellular network 225 where network bandwidth resources are limited. Even for relatively resource-richer broadband settings, consumption context can be relevant because many people may have multiple devices running multiple applications concurrently. It is important to ensure that resource intensive video streaming applications do not use more bandwidth than necessary for the identified consumption context.

FIG. 2B depicts an illustrative embodiment of an example, non-limiting embodiment of a system in accordance with various aspects described herein. It is found that ABR streaming is the de facto technology used for video streaming over the Internet. In ABR streaming, a media server 240 can provide multiple tracks or variants that all represent the same content but can be encoded at different bitrates and quality levels. Each track can be divided into multiple segments, each containing a few seconds worth of content. During playback, for each segment position, the client application can use ABR rate adaptation logic to dynamically select a variant from the multiple available variants to adapt to dynamic network conditions. At the media server 240, video and audio can either be “muxed” (i.e., each video track in the ladder of video track variants is muxed, or combined, with an audio track variant and stored and streamed as a single composite track), or “demuxed” (i.e., the video track variants and the audio track variants are stored and streamed as separate tracks). The demuxed approach can provide many advantages in reducing overhead in the media server 240 and the media content database 235 and improving CDN cache hits. In “demuxed” ABR streaming, the rate adaptation logic, which is typically at the client application, can determine both the video track variants and the audio track variants to fetch from the media server 240 for each segment position. The “demuxed” audio/video track approach can provide many advantages and is widely adopted in popular streaming services.

In one or more embodiments, the “demuxed” approach can be combined with the “muxed” approach. It is found that consumption context can holistically improve the entire end-to-end path of ABR streaming, including the media server 240, CDN, the client application at the communication device 216A, and the Internet network 230 and carrier network 225, because of the large amount of resources and bandwidth consumed by video streaming. For last-mile networks, this can be clearly relevant for resource-constrained cellular networks. Even for relatively resource-richer broadband settings, this can be relevant since many people have multiple devices running multiple applications concurrently. It is important to ensure that the resource-intensive video streaming applications not use more bandwidth than necessary for the current consumption context.

In one or more embodiments, the environment in which a user streams and consumes the audio/video can be called a consumption context. The consumption context can include the network connection (i.e., cellular or WiFi), multimedia decoding capabilities (e.g., highest frame rate and resolution supported, codec types supported), the specific setup of the audio/video device (i.e., playing directly using the built-in speaker or native display of the mobile device or using external peripherals, and their respective playback capabilities), and other relevant information (e.g., orientation of the mobile device, streaming protocol used between the player and server). The consumption context can be an important factor to consider in ABR streaming to optimize QoE and network resource usage. It is found that network condition can be one important component in the consumption context, but other important dimensions of consumption context need to be considered to optimize QoE and network resource usage. Due to the nature of user perception, different amounts of resources may be needed to deliver the same “good quality” in different contexts. For example, when the mobile device 216D is connected to a large-screen display 220C, good viewing experience may require streaming in higher-resolution, higher-bitrate video tracks (e.g., 1080p or 4K) over the network 225. In contrast, when the video is viewed on the smaller sized display of the mobile device 216A itself, lower-resolution lower-bitrate video tracks (e.g., 480p or 720p) might be sufficient. In some cases, there can indeed be more value in streaming a higher quality video or audio track in a particular consumption context, if, in fact, the corresponding experience could be faithfully reproduced for the user. However, the limitations of the display and speaker capabilities of the communication device 216A can limit the effective QoE the user will actually experience.

FIG. 2C depicts a block diagram of an audio system. It is known that 5.1-channel and 2-channel audio tracks can deliver very different experiences when being played over a 5.1-channel capable sound system. But what happens if the playback system, such as a communication device, 216A includes only a built-in, stereo (2 channel) speaker, while the audio tracks include 5.1 channel audio. In this situation, the ABR client application player can still stream and decode the 5.1 channel track. It will need to “downmix” the 5.1 channel track to a 2-channel track and then play the downmixed 2-channel track over the built-in stereo speaker. It is found that the resulting perceptual audio quality can be comparable to, or even worse than, the audio quality realized by streaming in a 2-channel track (instead of a 5.1 channel track) from the remote server and playing that track. Streaming the 2-channel track can have the additional advantage of typically including a lower bitrate than the 5-channel variant, so that streaming the 2-channel track instead of the 5-channel track can reduce the associated network resource usage. User expectations may also be conditioned depending on the consumption context. For instance, when playing audio with a surround sound system, the user may prefer the richer 5.1-channel experience over the 2-channel experience. However, when consuming the same content over a phone with a stereo speaker, the 2-channel experience may be perfectly acceptable.

FIG. 2D depicts audio quality measurements for downmixing six-channel audio to a two-channel (stereo) device. The ABR video track ladder for the video can include 6 video tracks (in this case, H.264 encoded), named V1-V6, in order of increasing encoding bitrates and video resolution (e.g., resolutions ranging from 144p to 1080p), and four audio tracks, named A1-A4, in order of increasing encoding bitrates; the first two tracks (A1 and A2) have two audio channels and the other two tracks (A3 and A4) have 6 channels (e.g., corresponding to 5.1 channel surround sound). A1 has the lowest encoding bitrate and A4 has the highest. One question of interest is “Do the two higher bitrate audio tracks, A3 and A4, lead to better QoE than the two lower bitrate tracks, A1 and A2?” The answer to this question is not straightforward. The answer depends on the number of channels that can be played out by the speaker system being used. In one example, the audio and video can be streamed over a cellular network and directly played back on a phone with built-in stereo (i.e., 2-channel) speakers. In this case, choosing 6-channel audio tracks for streaming is problematic and undesirable since (i) a 6-channel audio track will require to a downmix by the player to a 2-channel version, before it can be played back by the stereo speaker, (ii) the resultant downmixed audio has comparable quality to the audio experience that can be realized if the player selected, streamed, and played back the 2-channel audio tracks directly available from the server, and (iii) selecting an audio track with higher number of channels (and therefore a much higher encoding bitrate) can use up more of the available network bandwidth. This approach would leave less headroom for streaming the video content, and, therefore, may limit the choice of video tracks to lower quality lower bitrate video tracks. By streaming too large of an audio track bit with—larger than can be usefully reproduced—the ABR player can potentially cause the streaming of reduced resolution/quality video tracks, especially when the overall network bandwidth is low. Conversely, restricting the choice of audio tracks to those that match the speaker capability (e.g., A1-A2) can lead to better video quality, while not degrading audio quality.

FIG. 2E depicts audio quality measurements for downmixing six-channel audio to a two-channel (stereo) device. The results were obtained by running the popular opensource ExoPlayer™ client, a popular ABR player used by many leading streaming services on the Android™ platform. Both the video and the audio are directly played on a Pixel 4a phone with a cellular trace, using the DASH ABR standard for the above example video, where the average network bandwidth was 1.5 Mbps. Various metrics are shown, including audio track selection, audio quality measured using ViSQOL and PEAQ (both being perceptual audio quality metrics), and video track selection video quality (measured using VMAF a state-of-the-art perceptual video quality metric). The results are shown for two cases. The first case only allows 2-channel audio tracks (i.e., audio tracks suitable for stereo speakers, marked as A1-A2). The second case has no restriction (i.e., all 4 audio tracks are allowed, marked as A1-A4).

It is found that the A1-A2 case leads to significantly better video quality than the A1-A4 case. In the A1-A2 scenario, 91% of the video segments have VMAF values above 60 and no segment has VMAF below 40. The VMAF value ranges from 1 to 100, where below 40 is considered as poor quality and above 60 is considered as fair to good quality. In the A1-A4 scenario, only 80% of the segments have VMAF above 60, and 7% of the segments have VMAF below 40. Note that the improved video quality in the A1-A2 case does not come at the cost of lower audio quality. Instead, the A1-A2 scenario leads to similar or even better audio quality than the A1-A4 scenario. In the example, for earlier audio segments, the A1-A2 scenario demonstrated higher quality than the A1-A4 scenario, because the latter scenario resulted in the selection of A3, which had to be downmixed to A3,′ and demonstrated lower scores than A2 that is selected by the A1-A2 scenario. For the later segments in the video session, both scenarios demonstrated good quality (e.g., mostly above 4 for ViSQOL and above −1 for PEAQ).

Matching the video track selection with the display capabilities and requirement of the specific consumption context is also found to increase overall QoE for the user. A lot of focus is currently placed on delivering very high quality content in many services, even for small screens such as phones. As an example, a new version of the YouTube′ player allows users to stream 4K videos on Android devices (even small-screen phones). A test scenario was evaluated, where a 4K video track was streamed over an LTE network to a Samsung phone having a screen resolution of only 1440p (substantially less than 4K). The associated data usage was found to be very substantial (several tens of Mbps), while the associated quality improvement from streaming such a high resolution content to the small screen device was not demonstrable, due to human perception limitations. In another example, studies have shown very little video quality gain for delivering content with resolution beyond 720p on small screens. In addition, streaming and playing these 4K resolutions can lead to higher phone energy consumption and/or video stalls. which are both undesirable. Several existing video players are found to exhibit similar problematic behaviors. In summary, given the relatively small screen size of a smartphone, the limits of human perception, and the limited bandwidth on cellular connections, it can be more desirable to moderate the video track variant selection during the ABR adaptation process to achieve a “good” resolution (e.g., 720p and below). This approach can lead to a similar viewing quality as the highest 1080p resolution track, while significantly reducing data usage, the likelihood of stalls, and/or energy consumption.

FIG. 2F depicts differences between two adaptive bit rate protocols. DASH and HLS are the two most predominant protocols for ABR. DASH and HLS can differ in important ways in terms of the actual information communicated between the server and client. As an example, for demuxed video and audio, DASH only specifies individual audio/video tracks and their bitrates. DASH does not specify desired audio and video track combinations. By contrast, HLS uses a top-level master playlist that specifies the allowed audio and video track combinations and the average and peak bitrate of each combination. However, HLS but does not specify the bitrate of an individual audio or video track. The player logic needs to carefully account for these differences. It is found that appropriately incorporating consumption context into the ABR adaptation decision process can lead to significantly better tradeoffs in terms of QoE and network data usage.

FIG. 2G depicts an illustrative embodiment of an example, non-limiting embodiment of a system in accordance with various aspects described herein. In one or more embodiments, the system 250 can include the media server 240 and the communication device 216D. The media server 240 can provide media content in the form of audio tracks 251 and video tracks 252 to a client communication device 216D. The client communication device 216D can include an operating system (OS) 256 and systems for an internal audio speaker 253, a display 254, and network interface 255. The client communication device 216D can also include one or more peripheral interfaces 262 for connection to external displays 220C and/or external audio systems 220D. The client communication device 216D can include an internal media player 261 for controlling the streaming and presentation of the media content. The internal media player 261 can include ABR logic 260 and customization policies 259. The internal media player 261 can include a consumption context collector 257 and a consumption context filter 258.

In one or more embodiments, the consumption context collector 257 can detect a video session for streaming a content item over a network from a media server 240 to the client application at the client communication device 216D. In response, the consumption context collector 257 can collect or monitor consumption context information from the OS 256. This consumption context information can include information on how the client communication device 216D is currently configured for presentation of media content and how this configuration changes over time. For example, is an external sound system 220D or an external display 220C connected to the peripheral interface? Has an external sound system 220D or external display 220C been selected by the client communication device 216D for presenting sound or video? Is the client communication device 216D configured to use the internal audio speaker 253 or internal display 254?

In one or more embodiments, the consumption context collector 257 can make API calls to the OS 256 requesting various pieces of consumption context information. The consumption context information can include audio and video configurations, network connectivity information, such as cellular connection or WiFi connection, available network bandwidth, streaming protocol characteristics, and/or multimedia decoding capability. The consumption context information can include the orientation of the client communication device 216D and its display.

The consumption context collector 257 can determine one or more consumption contexts during the video session from the consumption context information. The consumption context collector 257 can generate one or more consumption contexts from the consumption context information. For example, the consumption context collector 257 can analyze the consumption information from the OS 256 and determine an audio output characteristic. This audio output characteristic can include an indication that the client communication device 216D is currently using its internal audio speaker system and that this audio speaker system provides a stereo audio output. Alternatively, the audio output characteristic can include an indication that the client communication device 216D is connected to an external surround sound system 220D and is currently configured to use this external sound system 220D.

In another example, the consumption context collector 257 can analyze the consumption information from the OS 256 and determine a video output characteristic. This video output characteristic can include an indication that the client communication device 216D is currently using its internal video display and that this video display provides a 720p video resolution. Alternatively, the video output characteristic can include an indication that the client communication device 216D is connected to an external video display 220C, is currently configured to use this external video display 220C, and that the video display provides 4K video resolution. In another example, the consumption context collector 257 can analyze the consumption information from the OS 256 and determine a network characteristic. This network characteristic can include an indication that the client communication device 216D is currently accessing data from a cellular network and that this cellular network provides a first bandwidth. The network characteristic can include an indication that the client communication device 216D is connected to a WiFi network and that the WiFi network provides a second bandwidth.

In one or more embodiments, the consumption context collector 257 can determine, from the consumption information, the current consumption context of the device, how the video and audio characteristics and the network characteristics change over time. This allows the device to select various combinations of video and audio tracks during an audio session to dynamically adjust to these changes.

In one or more embodiments, the consumption context collector 257 can receive track variant information from the media server 240 describing available audio and video tracks for the content item. The available audio and video tracks can include various resolutions that required different amounts of data and that, therefore, consume different levels of bandwidth during streaming. The consumption context collector 257 can then select a filtered set of the audio track and/or video track variants from the full set of available track variants. This selection can be based on the track variant information and the current consumption context that has been determined for the video session. The selection can also be based on customization policies 259 for the client communication device 216D. For example, if the consumption context collector 257 determines that the consumption context for the client communication device 216D is to use the internal speaker system and an external display device 220C, then the customization policies 259 for client communication device 216D may dictate that the consumption context collect 257 filter out the available audio and video tracks to remove all surround sound audio tracks so as not to waste network bandwidth on the audio tracks of a type that exceeds the capabilities of the sound reproduction system.

In one or more embodiments, the ABR logic 260 can request and receive from the media server 240 a data stream including an audio track and a video track for the content item from the filtered set of audio track and video track variants. By only requesting and receiving audio and video track variants from within the filtered set of variants, the ABR logic 260 can reduce the required network bandwidth for the data stream while optimizing for the current consumption context. The ABR logic 260 can present the content item via the consumption context audio and video resources using the received audio and video tracks.

FIG. 2H depicts an illustrative embodiment of a method 270 in accordance with various aspects described herein. In step 271 of the method 270, a client application at the communication device 216D can receive variant information for available audio and video track variants of the content item. In step 272, the client application can determine if additional segments of the content item remain and, if so, then the client application can obtain current consumption context information for the communication device 216D for the segment, in step 273. In one embodiment, the current consumption context information can be obtained via an API call the OS of the communication device. In step 274, the client application can determine the current consumption contexts for the communication device during this segment of the content item in this video session based on the current consumption content information.

In step 275, the client application can select a filtered set of audio track and video track variants for this segment from the available audio and video track variants base on the variant information, a consumption policy, and the current consumption context. In step 276, the client application can select an audio track and a video track from the filtered set of audio track and video track variants according to the dynamic network condition. In step 277, the client application can request and receive a data stream from the media server 240 that includes the audio track variant and the video track variant. In step 278, the client application can present the segment of the content item at audio and video outputs of the communication device 216B based on the audio track and video track variants.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2I depicts an illustrative embodiment of a method 280 in accordance with various aspects described herein. In step 281 of the method 280, a client application at the communication device 216D can detect a video session for streaming a content item from a media server 240 to the client communication device 216D and, if detected, then the client application can determine if any segments remain in the content item in step 282. If so, then client application can obtain consumption context information for the communication device 216D for the current segment, in step 283. In one embodiment, the consumption context information can be obtained via an API call to the OS of the client communication device. In step 284, the client application can determine one or more consumption contexts for the communication device during the current segment based on the consumption content information.

In step 285, the client application can receive variant information for available audio and video track variants of the content item. In step 286, the client application can select a filtered set of audio track and video track variants from the available audio and video track variants for the segment based on the variant information, a consumption policy, and the one or more consumption contexts. In step 287, the client application can select an audio track and a video track from the segment from the filtered set of track variants based on a dynamic network condition for this segment. In step 288, the client application can request and receive a data stream from the media server 240 that includes the audio track variant and the video track selected. In step 289, the client application can present the content item at audio and video outputs of the communication device 216B based on the audio track and the video track selected.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, the client application can identify a consumption context and use it holistically when making decisions about what quality video and audio to stream from the server to the client player during ABR streaming, to optimize QoE and network resource usage. These decision can be important for the entire end-to-end path of ABR streaming, including the media the server, CDN, client and the network, because of the large amount of resources and bandwidth consumed by video streaming. A consumption context based approach may have the potential for selecting video and audio track variants that better match the specific consumption context, providing benefits in improving QoE, while avoiding the waste of scarce network resources due to selecting and streaming unnecessarily high bitrate track variants. For last-mile networks, selecting optimal video and audio variants can be very valuable, especially when the mobile device is connected to a cellular network and network bandwidth resources are relatively limited. Even for relatively resource-richer broadband settings, selection of the optimal video and audio variants can be useful in situation, where many people have multiple devices running multiple applications concurrently. It is important to ensure that the resource intensive video streaming applications do not use more bandwidth than necessary for the current consumption context.

In one or more embodiments, a client player can send the consumption context information to the server. Based on the specific context, the server can select a subset of the audio/video tracks, create a consumption context-specific manifest file including the information for this subset of tracks, and send the manifest file to the client so as to restrict the track selection to those tracks suitable to the current consumption context. As an example, if the context indicates that a 2-channel speaker is being used for audio playback at the client, then the server can only include the 2-channel audio tracks in the ABR manifest file it shares with the client, thereby constraining the client to limit its audio track selections to 2-channel audio tracks. This approach can be a significant step forward beyond the use of device-specific manifest files in some services.

Although the latter approach does customize the manifest files (that contain info about available audio and video tracks) separately for small-screen and large-screen devices (e.g., allowing high bitrate tracks only for large-screen devices), it still does not address the increasingly common scenario where a small-screen device might, in reality, be used in a different consumption context (e.g., when the small screen device streams in the video from the remote server, but then displays the video on an external large-screen peripheral). In one or more embodiments, the consumption context is not static but can change during the video session and can be tracked and accounted for automatically in a dynamic manner during playback. If the consumptions context changes in the middle of a streaming session, the changed context information can be sent to the server so that the server can send an updated manifest file to the client application. For example, if the communication device 216D begins the video session playing audio on its built-in stereo speakers but is connected to a surround sound system later in the streaming session, then the corresponding context can change and can be conveyed to the server. The server can then update the context-specific manifest file listing audio and video tracks to include 6-channnel audio tracks. Client to server communication can realized in a variety of ways in the context of typical ABR workflows, including through the use of an HTTP-based query-response interface between the client and server. A longer term solution could involve building this communication into the ABR protocol specification (e.g., HLS/DASH) itself. A key feature and advantage of such a server-based scheme for consumption context ABR streaming is that it can be designed to work in conjunction with existing ABR adaptation logic and does not require changes to that adaptation logic itself. This can make it possible for a wide base of services for existing, deployed ABR technologies to easily benefit from a consumption context technique.

In one or more embodiments, a client-based approach for context cognizant ABR streaming can be used as an alternative to the server-based approach described above. In a client-based approach, the client application can be cognizant of its current consumption context (e.g., device capabilities, peripheral devices, network type), and can filter out audio/video tracks accordingly. As a result, a subset of audio/video tracks can be fed to the ABR logic, restricting the ABR logic from selecting tracks that are not suitable for the current consumption context.

In one or more embodiment, consumption context-based filtering of track variant option can be performed inside the player or outside the player based on additional customization policies. The customization policies can be determined or modified by users. Alternatively, when incorporating consumption context inside the ABR player, it can be easier for a streaming service to create customized consumption context-cognizant experiences for end users based on its specific business needs. Consumption context can be accounted for automatically in a dynamic manner during the playback, and hence it can be incorporated at the player level, based on dynamic consumption context collected by the player in real time, and requiring no manual input from the users.

In one or more embodiments, the client-based design, as shown in FIG. 2G, can architecturally reside within the player software. The server 240 can have a set of available audio and video tracks variants. Each audio track can be associated with a set of attributes, such as the number of channels in the encoding, the sampling rate, and/or codec. Similarly, each video track can be associated with a set of attributes, such as the resolution, and/or codec. Track variant information regarding the audio and video tracks can be passed from the server 240 to the client communication device 216D, through an ABR manifest file using an ABR streaming protocol, such as DASH or HLS protocol. On the client side, the consumption context can include one or more characteristics. For example, the consumption context can include the audio speaker and its capabilities, including the number of channels of the speaker, the range of sampling rate that can be supported by the speaker. The consumption context can include the display and its capabilities, including the resolution and size of the display. The consumption context can include multimedia decoding capabilities supported by the player, such as highest frame rate and resolution supported, and codec types supported. The consumption context can include the network connectivity, or whether the connection is through cellular or WiFi. The consumption context can include miscellaneous characteristics, including the current orientation of the phone (landscape or portrait) and languages preferred by the user.

In one or more embodiments, the specific ABR protocol being used between the server and client can be an important component of the consumption context, since different ABR protocols can differ in terms of the specific information shared in the ABR manifest file or how the specific information is represented in the manifest file. These differences can have significant impacts on the ABR logic and resulting QoE of the video session. In one embodiment, the various consumption context information, the media attributes in the manifest files, and other information, such as client buffer level or network bandwidth estimation, can be considered as a group by the ABR logic when determining which audio and video tracks to fetch from the server for each segment position or playback position in the video. The client player software can be cognizant of its current consumption context and can use this to information to perform consumption context-based filtering to eliminate from consideration audio/video tracks that do not match or are not suitable for the consumption context. This consumption context-based filtering can be an additional module supplementing the existing core ABR logic in the client player. As a result, only a subset of the available audio/video tracks will be fed to the ABR logic, restricting it from selecting tracks that are not suitable for the current consumption context. For example, suppose that at the beginning of the video session the audio is being played over a 2-channel speaker on the communication device 216D. In this scenario, only 2-channel audio tracks will be fed to the ABR logic. However, if the client application determines that communication device has been connected to a surround sound system later during the video session, then all of the available audio tracks can be fed to the ABR logic, so that 6-channel audio tracks are available for selection by ABR logic.

In one or more embodiments, the consumption context collector 257 and the consumption context filter can be added to the design of an existing player 261. The consumption context collector 257 can collect consumption context information from the lower layers, such as the underlying OS 256, or other sources, and from the media server 240. The consumption context filter can filter out audio/video tracks from the available audio/video track variants based on the current consumption context. Each of these components 257 and 258 can run continuously during the playback. The consumption context collector 257 can feed the consumption context information to the consumption context filter, which interacts with the core ABR logic. The customization policies 259 can be outside the player and can include any policies specified or selected by the user, such as user-selection of “Play HD on Wi-Fi only.” The customization policy information 259 can also be passed to the consumption context-based filter 258 and can be considered together with the consumption context information by the consumption context-based filter 258 in filtering decision process. As a result, only the audio/video tracks that are suitable for the current consumption context and customization policy can be selected by the ABR logic 260.

In one or more embodiments, the client application at the communication device 216D can be cognizant of its current consumption context and can use this information to take any required actions on the client side of the video session, such as performing consumption context-based filtering and/or determining what video/audio track to download. The media server 240 can have substantially more knowledge of the media content than the client application. Therefore, the media server 240 can assist the client in its consumption context decisions through some additional information or hints. For example, the media server 240 can know that the media content is high motion sports content and can indicate to the client application a subset of the available track variants suitable or optimal for this aspect of consumption context. Hints from the media server 240 can be included in the manifest file or can be shared out-of-band.

It is found that the embodiments extend the OS 256 by adding a layer of automatic and real-time consumption context information collection and filtering inside the player 261. This added layer is outside the ABR logic 260 and can be easily incorporated into existing players, without any changes to the ABR logic 260. By filtering out audio/video tracks inappropriate for the current consumption context and feeding the information regarding the tracks appropriate to the consumption context, to the player ABR logic 260, this added layer makes it easier for the ABR logic 260 to select the appropriate tracks that will achieve a better tradeoff between QoE and resource usage. This approach also makes it easier and more practical to realize the benefits of consumption context-appropriate policies and choices for ordinary users, who do not have deep technical understanding of the various resource and performance tradeoffs. Specifically, the player 261 can make choices appropriate for the current consumption context without requiring users to know the exact consumption context all the time, while still allowing users to provide their input to customize the consumption context-based filtering. The technique is thereby designed to work in conjunction with existing core ABR adaptation logic 260 that is, generally, unaware of the consumption context, allowing incorporation of consumption context into for a wide base of services using existing and deployed ABR technologies.

In one or more embodiments, the consumption context-based filter 258 can use consumption context holistically. The decision on what audio or video track variants should be filtered does not need to be based only on the available network bandwidth and/or what type of audio/video coding can be decoded and played in the current consumption context. Rather, the consumption context filter 258 can also take account of the capabilities of the specific output devices on which either the video is displayed, or the audio is played, and the type of network connection. Both audio and video track selection can be moderated by taking consumption context into account based on what truly brings value to the users in the specific consumption context, instead of just what tracks the player can decode and play on that device 216D. For example, if the communication device 216D is using a 1440p display, it is not useful to bring in a 4K video track, even if the device 216D is technically able to play it. The player 261 would need to down sample the resolution of the 4K video to the lower screen resolution (1440p) before displaying the video. There would no perceptual quality benefit accrued to the user for using the 4K video, but there may well be significant additional associated network data usage caused by streaming the high-bitrate UHD 4K track. The consumption context filter 258 can simply avoid this situation by filtering out the 4K track as a possible streaming option. Similarly, the consumption context filter 258 may even filter out the 1440p video track, in spite of the on-device 1440p capability, because of a small screen size. Due to the nature and limitations of human visual perception, the user may not perceive the difference between 1440p video and 1080p video on a small sized screen. In this case, playing the lower bitrate 1080p track could deliver a similar visual experience with a much lower network data usage.

In one or more embodiments, this holistic approach to filtering out track options can be applied to audio tracks. For example, high bit rate 6-channel audio can be used as the audio source on the communication device 216D, even if it is only using the internal stereo speakers. However, there is no utility in streaming high-bit rate 6-channel audio track over the network, since the player will be required to downmix the track to a 2-channel version before playing it over the 2-channel audio speaker. In this scenario, it is much better to stream a lower bit rate 2-channel audio track over the network, which can save network capacity that can be better used in other ways, such as for streaming in higher quality video tracks. The consumption context approach allows the communication device to make this kind of holistic decision by considering multiple consumption context factors or dimensions at the same time.

In one or more embodiments, the client player 260 can explicitly consider tailor its context-aware adaptation decisions based on the specific ABR protocol that is being used and the information it provides. The ABR protocol that is used between the server 240 and the client device 216D can be an important component of the context, since it can lead to different ways of representing information in the manifest file. For example, the bitrate representation for audio and video tracks can be different for different ABR protocols. Also, different ABR protocols can include somewhat different types of information their manifest files, which can have significant impact on the context-aware adaptation and resultant QoE. In particular, the DASH and HLS specifications (the two predominant ABR protocols) have subtle but significant implications that need to be explicitly accounted for by any client player that serves both protocols. However, some popular player implementations are not cognizant of these important differences and may apply the same player logic designed for one protocol (DASH) to the other protocol (HLS), while ignoring these little understood differences between HLS and DASH that have important implications in terms of undesirable ABR selections and poor QoE in general. For example, one key difference between DASH and HLS is that DASH provides bandwidth requirements of individual audio and video tracks in the DASH manifest file. While HLS does not provide encoding bitrates for individual audio or video track in its top-level, master manifest. Instead, HLS only provides the total bandwidth requirements and for specified allowed audio and video track combinations (pairs) in the top-level master manifest file. Therefore, with HLS protocol, the client lacks important information regarding the bitrates for the different audio tracks, which important information for the consumption context-based filtering of track variants. To account for this difference, the consumption context filter 258 must treat information from an HLS manifest in a different than it treats manifest information from DASH in order to avoid undesirable ABR track selection decisions. This is true even in the presence of CMAF packaging, which allows a single packaging to be used for DASH and HLS, obviating the need for multiple packaged copies of the same underlying content. In the CMAF case, the differences between DASH and HLS specifications still matter and require careful treatment.

In one or more embodiments, the consumption context information can be obtained by the consumption context collect 257 using standard API calls to the OS 256. For example, standard API calls can be used to access consumption context information regarding audio/video device and network type for Android™ device and for Chrome™ devices.

In one or more embodiments, a proof-of-concept prototype implementation of context-cognizant ABR streaming has been created by modifying a popular opensource ExoPlayer™ client. FIG. 2J-2K depict audio/video quality and data usage measurements for playback of content on a phone device during periods of low and high network bandwidth. Through a wide range of experiments under real-world scenarios, it is found that consumption context ABR achieves significantly better tradeoffs between QoE and resource usage than the standard ExoPlayer™. For example, under low network bandwidth settings, it improves video quality by reducing low-quality video segments (e.g., by 17%), while leading to similar audio quality and slightly lower data usage compared to the non-consumption context case. When the available network bandwidth is high, it leads to significantly lower resource usage on the end-to-end path (e.g., using only 13% of the bandwidth used by the standard ExoPlayer™), while still realizing good QoE for the specific consumption context.

FIG. 2L depicts content quality and bandwidth usage for playback on a phone device over a home WiFi network. The prototype can recognize and react to dynamic consumption context changes and adjust audio/video track selection accordingly. While the prototype implementation and evaluation focus on the use cases of displaying the video on the phone screen vs an external display and playing the audio over the phone's built-in stereo speaker vs an external surround sound system, consumption context ABR best practices can be applied directly to other consumption context cases such as displaying video using a projector and playing the audio using headphones.

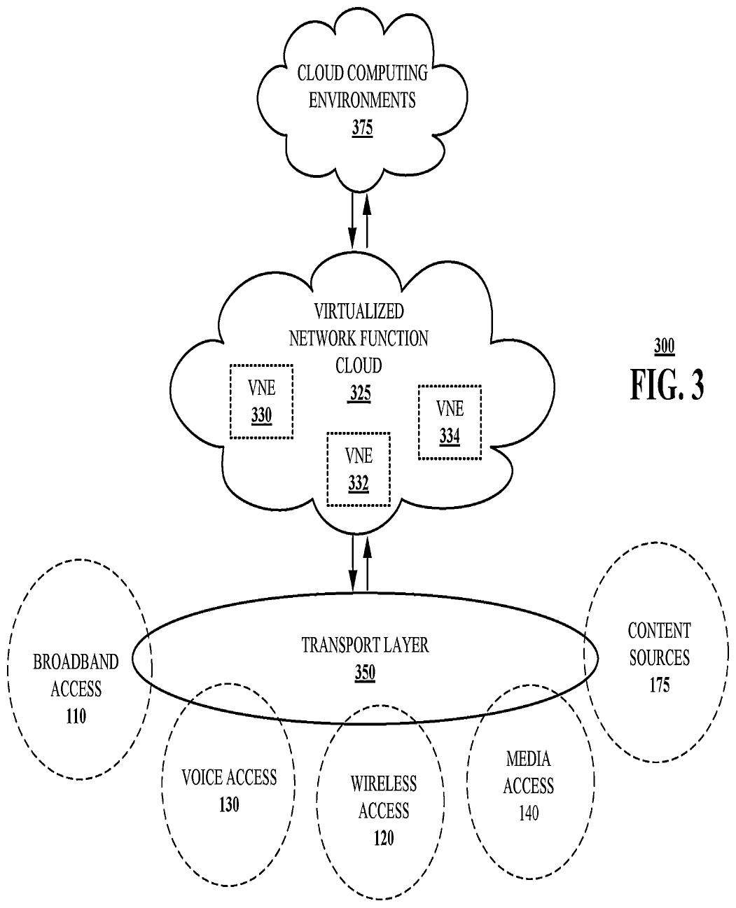

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part adjusting a streaming bit rate of a content item during a video session by selecting audio/video tracks based on consumption context. The consumption context is determined from consumption context information obtained from the device. Selections of audio/video tracks are made based on the consumption context and consumption policy to optimize quality of experience and bit rate.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

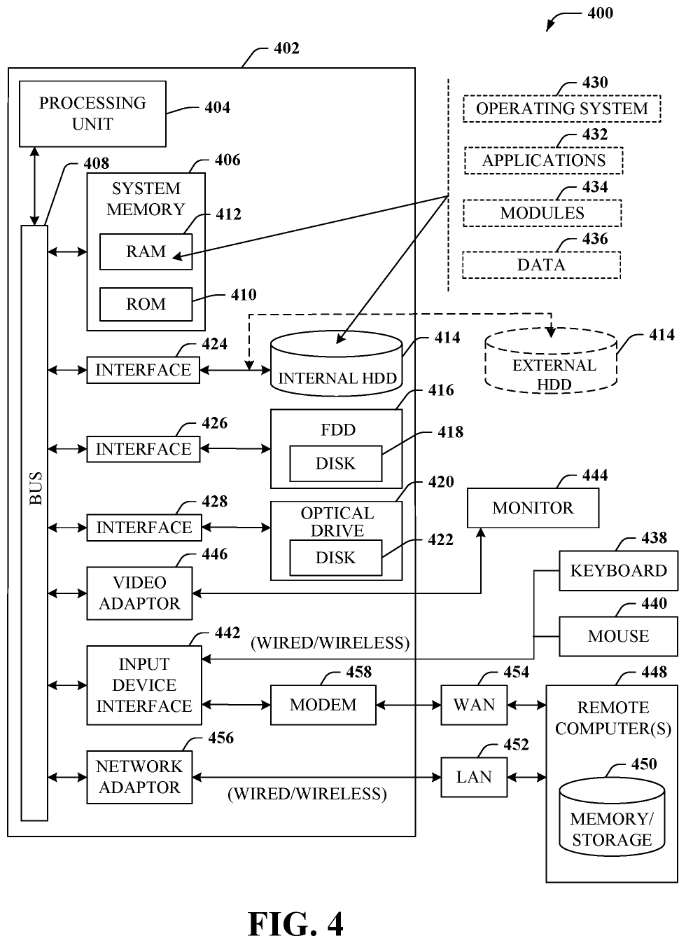

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part adjusting a streaming bit rate of a content item during a video session by selecting audio/video tracks based on consumption context. The consumption context is determined from consumption context information obtained from the device. Selections of audio/video tracks are made based on the consumption context and consumption policy to optimize quality of experience and bit rate. Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

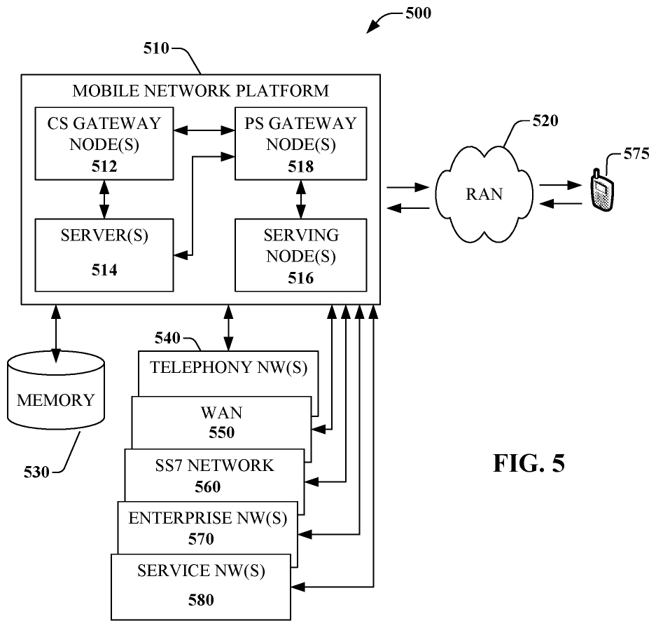

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part adjusting a streaming bit rate of a content item during a video session by selecting audio/video tracks based on consumption context. The consumption context is determined from consumption context information obtained from the device. Selections of audio/video tracks are made based on the consumption context and consumption policy to optimize quality of experience and bit rate. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

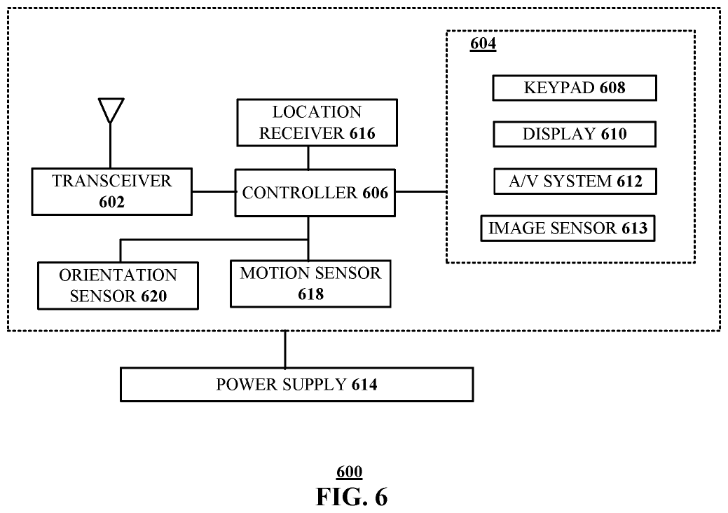

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part adjusting a streaming bit rate of a content item during a video session by selecting audio/video tracks based on consumption context. The consumption context is determined from consumption context information obtained from the device. Selections of audio/video tracks are made based on the consumption context and consumption policy to optimize quality of experience and bit rate.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, track variant information from a server over a network, wherein the track variant information describes a plurality of audio track and video track variants for a plurality of segments of a content item; and
for each segment of the plurality of segments of the content item during presentation of the content item:
obtaining, by the processing system, current consumption context information;
determining, by the processing system, a current consumption context for the segment according to the current consumption context information, wherein the current consumption context includes a video output characteristic, an audio output characteristic, a network characteristic, or any combination thereof;
selecting, by the processing system, a filtered set of audio track and video track variants for the segment from a plurality of audio track and video track variants for the content item according to the current consumption context, the track variant information, and a consumption policy;
determining, by the processing system, a dynamic network condition for the segment;
selecting, by the processing system, an audio track and a video track for the segment from the filtered set of audio track and video track variants for the segment according to the dynamic network condition;
receiving, by the processing system, a data stream for the segment from the server over the network, wherein the data stream includes the audio track and the video track for the segment selected from the filtered set of audio track and video track variants according to the dynamic network condition; and
presenting, by the processing system, the segment of the content item according to the audio track and the video track via a video output and an audio output.

2. The method of claim 1, further comprising detecting, by the processing system, a video session for streaming the content item from the server over the network.

3. The method of claim 1, wherein the selecting the audio track and the video track for the segment from the filtered set of audio track and video track variants for the segment is further according to network bandwidth, adaptation logic, adaptation policy, or any combination thereof.

4. The method of claim 1, wherein the current consumption context for the segment differs from a prior consumption context for a prior segment due to a change in the video output characteristic.

5. The method of claim 1, wherein the current consumption context for the segment differs from a prior consumption context for a prior segment due to a change in the network characteristic.

6. The method of claim 1, wherein the current consumption context for the segment differs from a prior consumption context for a prior segment due to a change in the audio output characteristic.

7. The method of claim 1, wherein the obtaining the current consumption context information comprises performing an application programming interface (API) call to an operating system.

8. The method of claim 1, wherein the video output characteristic includes a multimedia decoding capability, an orientation characteristic, or any combination thereof.

9. The method of claim 1, wherein each audio track and video track variant of the plurality of audio track and video track variants for the segment are a selectable pair.

10. A device, comprising:
a processing system including a processor; and
a memory that stores executable instructions that, when executed by the processing system, facilitate performance of operations, the operations comprising:
receiving track variant information from a server over a network, wherein the track variant information describes a plurality of audio track and video track variants for a plurality of segments of a content item; and
for each segment of the plurality of segments of the content item during presentation of the content item:
obtaining current consumption context information;
determining a current consumption context for the segment according to the consumption context information;
selecting a filtered set of audio track and video track variants for the segment from the plurality of audio track and video track variants for the content item according to the current consumption context, the track variant information, and a consumption policy, or any combination thereof;
determining a dynamic network condition for the segment;
selecting an audio track and a video track for the segment from the filtered set of audio track and video track variants for the segment according to the dynamic network condition;
receiving a data stream for the segment from the server over the network including the audio track and the video track for the segment selected from the filtered set of audio track and video track variants according to the dynamic network condition; and
presenting the segment of the content item according to the audio track and the video track for a plurality of segments of the content item via a video output and an audio output.

11. The device of claim 10, wherein the operations further comprise detecting a video session associated with streaming the content item over the network from the server to a client application.

12. The device of claim 10, wherein the obtaining the current consumption context information further comprises performing an application programming interface (API) call to an operating system.

13. The device of claim 10, wherein the current consumption context for the segment includes a video output characteristic, an audio output characteristic, and a network characteristic.

14. The device of claim 10, wherein the selecting the audio track and the video track for the segment from the filtered set of audio track and video track variants for the segment is further according to network bandwidth, adaptation logic, adaptation policy, or any combination thereof.

15. The device of claim 10, wherein the current consumption context for the segment differs from a prior consumption context for a prior segment due to a change in a video output characteristic, an audio output characteristic, or any combination thereof.

16. The device of claim 10, wherein the current consumption context for the segment differs from a prior consumption context for a prior segment due to a change in a network characteristic.

17. The device of claim 10, wherein each audio track and video track variant of the plurality of audio track and video track variants for the segment are a selectable pair.

18. A non-transitory machine-readable medium, comprising executable instructions that, when executed by a device comprising a processing system including a processor, facilitate performance of operations, the operations comprising:
for each segment of a plurality of segments of a content item during presentation of the content item:
obtaining current consumption context information;
determining a current consumption context for the segment according to the consumption context information;
selecting a filtered set of audio track and video track variants for the segment from a plurality of audio track and video track variants for the plurality of segments of the content item according to the current consumption context and track variant information;
selecting an audio track and a video track for the segment from the filtered set of audio track and video track variants for the segment according to a dynamic network condition;
receiving a data stream for the segment from a server over a network including the audio track and the video track for the segment selected from the filtered set of audio track and video track variants according to the dynamic network condition; and
presenting the segment of the content item according to the audio track and the video track for a plurality of segments of the content item via a video output and an audio output.

19. The non-transitory machine-readable medium of claim 18, wherein the obtaining the current consumption context information is further by performing an application programming interface (API) call to an operating system.

20. The non-transitory machine-readable medium of claim 18, wherein the current consumption context for the segment differs from a prior consumption context for a prior segment due to a change in a video output characteristic, an audio output characteristic, or any combination thereof.
